(19) United States
(12) Patent Application Publication
(10) Pub. No.: US 2017/0206685 A1
(43) Pub. Date: Jul. 20, 2017

(54) ENSURING CONTRAST FOR TEXT WITHIN A WEB PAGE

(71) Applicant: Microsoft Technology Licensing, LLC, Redmond, WA (US)

(72) Inventors: Rossen Atanassov, Bellevue, WA (US); Bogdan Brinza, Seattle, WA (US)

(21) Appl. No.: 14/997,408

(22) Filed: Jan. 15, 2016

(51) Int. Cl. G06T 11/60; G06F 17/30; G06F 17/22; G06F 17/24; G06T 7/40; G06K 9/46

(52) U.S. Cl. CPC G06T 11/60; G06T 7/408; G06K 9/4652; G06F 17/2247; G06F 17/24; G06F 17/3089

(57) ABSTRACT

A facility for modifying a web page for display is described. The facility identifies within the web page one or more text blocks. The facility causes to be injected into the webpage immediately beneath the identified text blocks one or more visually homogenous panels.

### BACKGROUND

Web pages are documents typically presented by browsers. They can contain a variety of visual elements, such as text, images, and video or animation sequences.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for modifying a web page for display is described. The facility identifies within the web page one or more text blocks. The facility causes to be injected into the webpage immediately beneath the identified text blocks one or more visually homogenous panels.

### DETAILED DESCRIPTION OF THE DRAWINGS

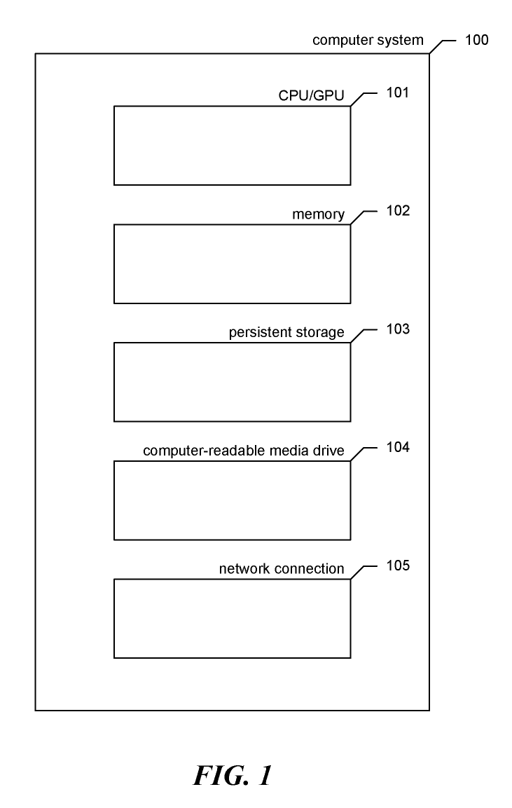

FIG. 1 is a block diagram showing some of the components that may be incorporated in at least some of the computer systems and other devices on which the facility operates.

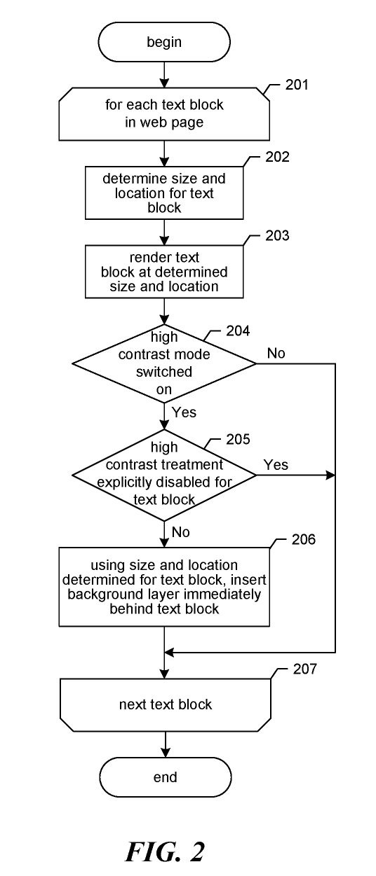

FIG. 2 is a flow diagram showing a process that may be performed by the facility in some examples to ensure contrast for text within a web page.

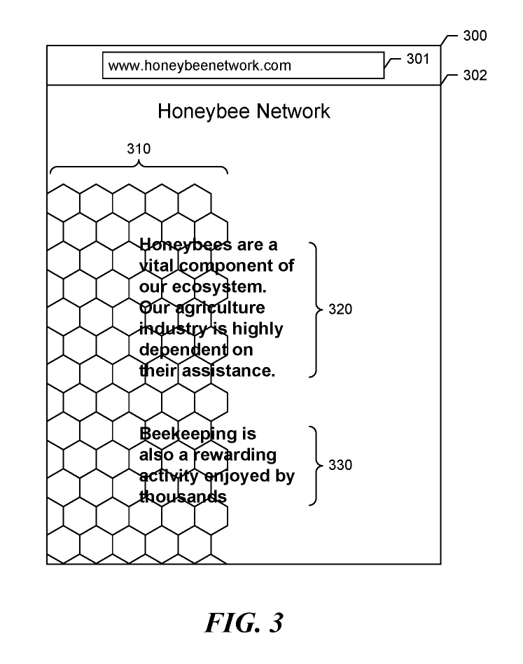

FIG. 3 is a display diagram showing a sample display in which high-contrast mode is turned off, such that the facility is generally inactive.

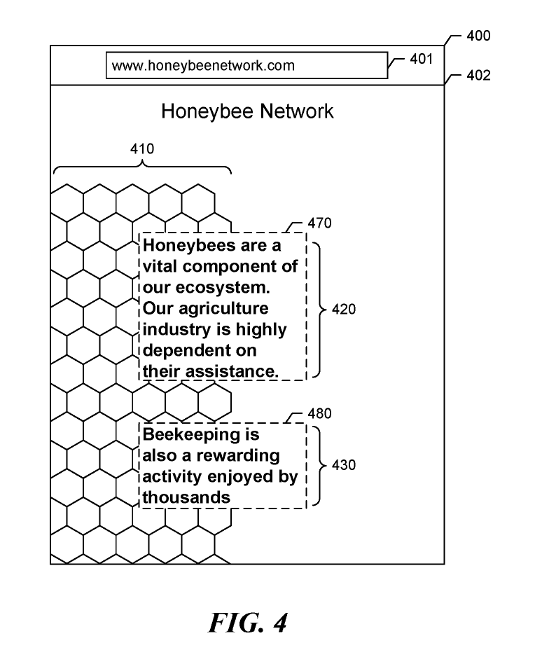

FIG. 4 is a first display diagram showing a sample display in which high-contrast mode is turned on.

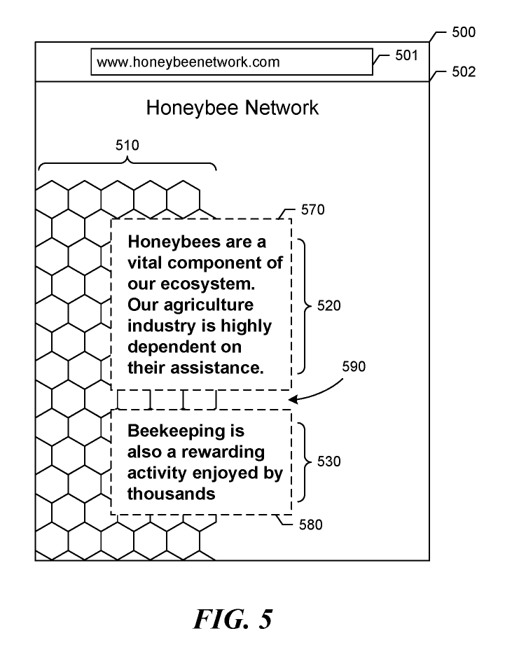

FIG. 5 is a second display diagram showing a sample display in which high-contrast mode is turned on.

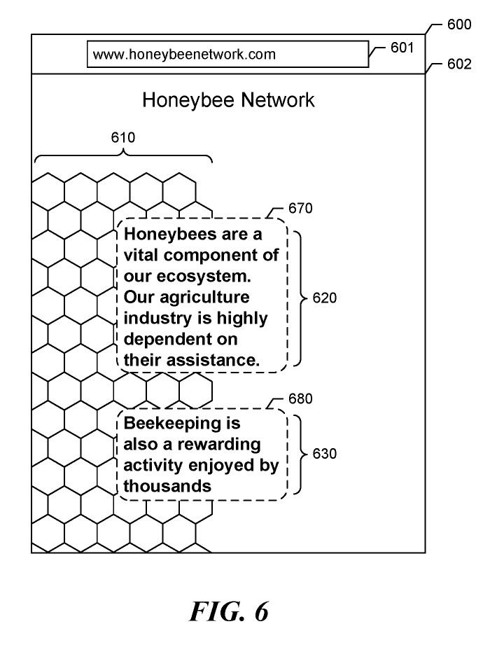

FIG. 6 is a third display diagram showing a sample display in which high-contrast mode is turned on.

### DETAILED DESCRIPTION

The inventors have recognized that many web pages can end up being displayed by browsers in ways that make their text difficult to read. This can occur, for example, where text is displayed on top of a background whose color is too similar to that of the text; where text is displayed over a visually complex image whose elements are difficult to distinguish from the text; where text is displayed over a video or animation sequence whose visual content changes over time; etc. These difficulties can be more acute for users with visual impairments, or at times when bright sunlight or a high level of ambient light from another source land on the display device.

In response, the inventors have conceived and reduced to practice a software and/or hardware facility for ensuring contrast for text within a web page (“the facility”).

In some examples, the facility inserts a visually homogenous layer—sometimes called a “panel”—into the web page behind text in the web page. The inserted layer obscures any background visual elements within the web page over which the text would otherwise have been displayed, providing a contrasting background against which to read the text, while at the same time preserving the visibility of those background elements in portions of the web page not containing text.

In some examples, the facility bases the area and placement of the inserted layer on the area and placement of a corresponding block of text, such as by establishing an inserted layer having the same area and placement as a rectangle bounding the block of text, such as a rectangle tightly bounding the block of text.

In some examples, the colors of both the text and the inserted layer are set externally to the definition of the web page, such as by setting at the operating system level a high-contrast mode foreground color (used for the text, overriding any color specified for the text by the web page) and a high-contrast mode background color (used for the inserted layer). In some such examples, the high-contrast mode foreground and background colors have preset defaults that can be changed by the user.

In some examples, the facility displays the text in a color specified for it by the web page, and selects a color for the inserted layer intended to contrast well with the text color.

In some examples, the operation of the facility can be toggled on and off by the user, such as by switching on and off a high-contrast mode of the operating system, switching on and off a high-contrast mode of the browser, or interacting with a particular text block within the browser, such as by hovering the mouse cursor over the text block, touching the text block, gazing at the text block, etc.

In some examples, the designer of a web page can direct the operation of the facility with respect to the web page, such as by employing one or more special styles associated with the facility. For example, in some examples, the web page's designer can: disable layer insertion for certain text blocks; set inserted layer and/or text color; set inserted layer opacity level, allowing background elements behind it to show through to different extents; specify a padding distance for the inserted layer—a margin or other minimum distance by which the inserted layer extends beyond the text; specify that the inserted layer have rounded corners of a particular radius; etc.

By performing in some or all of the ways described above, the facility ensures the readability of text in a web page while modifying the web page to a minimum extent, largely preserving its visual presentation and design.

FIG. 1 is a block diagram showing some of the components that may be incorporated in at least some of the computer systems and other devices on which the facility operates. In various examples, these computer systems and other devices 100 can include server computer systems; desktop computer systems; laptop computer systems; tablet computer systems; netbooks; mobile phones; personal digital assistants; smart watches, computing devices worn on the head such as virtual reality headsets, augmented reality headsets, and other head-mounted displays; televisions; cameras; automobile computers; electronic media players; electronic kiosk devices; electronic table devices; electronic whiteboard devices; etc. In various examples, the computer systems and devices may include any number of the following: a central processing unit (“CPU”) and/or graphics processing unit (“GPU”) 101 for executing computer programs; a computer memory 102 for storing programs and data while they are being used, including the facility and associated data, an operating system including a kernel and device drivers, and one or more applications; a persistent storage device 103, such as a hard drive or flash drive for persistently storing programs and data; a computer-readable media drive 104, such as a floppy, CD-ROM, or DVD drive, for reading programs and data stored on a computer-readable medium; a communications subsystem 105 for connecting the computer system to other computer systems and/or other devices to send and/or receive data, such as via the Internet or another wired or wireless network and its networking hardware, such as switches, routers, repeaters, electrical cables and optical fibers, light emitters and receivers, radio transmitters and receivers, and the like; and/or a display interface 106 through which the device can cause visual information such as a media player, media player controls, and media player content to be displayed on one or more display devices such as LCD panels, LED or OLED panels, CRTs, video projectors, holographic projectors, retinal projectors, virtual reality or augmented reality displays, etc.

FIG. 2 is a flow diagram showing a process that may be performed by the facility in some examples to ensure contrast for text within a web page. In some examples, the facility performs this process after the layout phase of displaying a web page, such as during the composition phase. At 201-207, the facility loops through each text block in the web page, such as by looping through each paragraph tag in the web page. At 202, the facility determines the size and location at which the text block is to be included in the web page. In some examples (not shown), the facility further determines a color in which the text block is to be displayed. At 203, the facility renders the text block at the size and location determined at 202. At 204, if a high-contrast mode is switched on—such as a high-contrast mode of the operating system or a high contrast of the browser—then the facility continues at 205, else the facility continues at 207. At 205, if high-contrast treatment is explicitly disabled for the text block, such as by specification of the value of “none” for a “-ms-high-contrast-adjust” attribute of the paragraph tag corresponding to the text block, then the facility continues at 207, else the facility continues at 206. At 206, inserts a background layer into the web page for the text block. In particular, the facility inserts the background layer so that it is immediately beneath the text block in the Z-order of the web page, at a size and location that is based on the size and location determined for the text block at 202, such that the background layer is immediately underneath the text of the text block.

In various examples, as discussed above, aspects of the layer inserted by the facility at 204 are controlled, for example, by system or browser settings, by attribute values or other directives included in the web page, etc. As one example, a sample style definition used by certain web page to control aspects of the layer inserted by the facility is shown below in Table 1.

TABLE 1

| | |
|---|---|
| 1 | @media (-ms-high-contrast: active) { |

| | |
|---|---|
| 2 | high-contrast-padding: 20px; |
| 3 | high-contrast-border-radius: 10px; |
| 4 | high-contrast-opacity: 0.75; |
| 5 | high-contrast-background-color: magenta |

| | |
|---|---|
| 6 | } |

In Table 1 above, rows 1 and 6 specify that a ms-high-contrast media feature used to control the facility is being defined. The ms-high-contrast media feature is further described by the Microsoft Developers Network at msdn.microsoft.com/en-us/library/windows/apps/hh465764.aspx. In row 2, the definition specifies twenty pixels of padding. Alternatively, the margins can be specified in the same way using this property. In row 3, the definition specifies that the corners of each panel are to be rounded at a radius of ten pixels. In row 4, the definition specifies that the panels are to have an opacity level of 75%. And in row 5, the definition specifies that the panels are to have the color magenta.

In some examples, the facility selects a color for the inserted layer based on the color determined for the text block at 202, such as by selecting a color known to provide good contrast with the color determined for the text block.

Returning to FIG. 2, at 207, if one or more additional text blocks remain to be processed, then the facility continues at 201 to process the next text block, else this process concludes.

In some examples (not shown), the facility merges panels that are adjacent vertically or horizontally to eliminate gaps between them, such as by merging adjacent panels that are less than a threshold distance apart.

Those skilled in the art will appreciate that the acts shown in FIG. 2 may be altered in a variety of ways. For example, the order of the acts may be rearranged; some acts may be performed in parallel; shown acts may be omitted, or other acts may be included; a shown act may be divided into sub-acts, or multiple shown acts may be combined into a single act, etc.

FIGS. 3-6 are display diagrams showing sample displays presented by the facility in some examples.

FIG. 3 is a display diagram showing a sample display in which high-contrast mode is turned off, such that the facility is generally inactive. A browser window 300 contains a rendered version of a web page 302 whose URL is shown in address bar 301. The web page includes two text blocks 320 and 330. It can be seen that a portion of each of these text blocks is displayed over a honeycomb image 310. While this honeycomb image 310 is an integral part of this web page added explicitly by the web page's designer, it may interfere with the readability of the text blocks for some users, particularly those with visual impairments.

In FIGS. 4-6, high-contrast mode is turned on, such that the facility is generally active. FIG. 4 is a first display diagram showing a sample display in which high-contrast mode is turned on. In FIG. 4, the same web page is displayed by a browser while high-contrast mode is turned on. In version 402 of the web page rendered by the browser, the facility has inserted panels 470 and 480. These panels obscure portions of the honeycomb image, and provide a contrasting background against which to read the text. The panels leave some portions of the honeycomb image unobscured, however, preserving design aspects of the web page to a significant degree.

FIG. 5 is a second display diagram showing a sample display in which high-contrast mode is turned on. In FIG. 5, the facility has increased the padding around the text blocks 520 and 530 relative to FIG. 4, thereby increasing the size of panels 570 and 580, such as based upon system configuration settings or in response to directives included in the web page by its designer. In some examples (not shown), because of the narrowness of intervening space 590 between the two panels, the facility merges panels 570 and 580 to eliminate this intervening space.

FIG. 6 is a third display diagram showing a sample display in which high-contrast mode is turned on. In FIG. 6, the facility has imposed curved corners on the panels 670 and 680, such as based upon system configuration settings or in response to directives included in the web page by its designer.

In some examples, the facility provides computing system for modifying a web page for display, the computing system comprising: a processor; and a memory having contents that, when executed by the processor: identify within the web page one or more text blocks, and without regard to any background elements of the web page that may occur beneath the identified text blocks in the web page, cause to be injected into the webpage immediately beneath the identified text blocks one or more visually homogenous panels.

In some examples, the facility provides one or more memories collectively containing a web page data structure, the web page data structure comprising: one or more text blocks; and a directive specifying an aspect of injecting one or more visually homogenous panels into the web page behind one or more of the text blocks during composition of the web page.

In some examples, the facility provides one or more memories collectively having contents configured to cause a computing system to: receive information specifying a web page, the received information specifying inclusion of one or more text blocks into the specified web page; construct the web page specified by the received information; and before the constructed web page is displayed, incorporate into the constructed web page one or more visually homogenous panels, the incorporated panels being below the text blocks in Z-order, the incorporated panels being above content of the web page specified by the received information to be below the text blocks in Z-order, the incorporated panels placed such that, for each character of any of each of the text blocks, one of the incorporated panel extends behind the character.

In some examples, the facility provides a method in a computing system, comprising: receiving information specifying a web page, the received information specifying inclusion of one or more text blocks into the specified web page; constructing the web page specified by the received information; and before the constructed web page is displayed, incorporating into the constructed web page one or more visually homogenous panels, the incorporated panels being below the text blocks in Z-order, the incorporated panels being above content of the web page specified by the received information to be below the text blocks in Z-order, the incorporated panels placed such that, for each character of any of each of the text blocks, one of the incorporated panel extends behind the character.

It will be appreciated by those skilled in the art that the above-described facility may be straightforwardly adapted or extended in various ways. While the foregoing description makes reference to particular examples, the scope of the invention is defined solely by the claims that follow and the elements recited therein.

We claim:

1. A computing system for modifying a web page for display, comprising:
one or more processors; and
memory having contents that, based on execution by the one or more processors:
identify within the web page one or more text blocks; and
without regard to any background elements of the web page that may occur beneath the identified text blocks in the web page, cause to be injected into the webpage immediately beneath the identified text blocks one or more visually homogenous panels.

2. The computing system of claim 1, further comprising a display interface configured to cause to be displayed the web page into which the panels have been injected.

3. The computing system of claim 1, wherein the memory further has contents that, based on execution by the one or more processors:
enable a user to configure a system setting that determines whether or not panels are to be injected into the web page.

4. The computing system of claim 1, wherein the memory further has contents that, based on execution by the one or more processors:
enable a user to configure a system setting that determines a color of the panels that are injected into the web page.

5. The computing system of claim 1, wherein the memory further has contents that, based on execution by the one or more processors:
determine a color for the panels that are injected into the web page based at least on a color of text among the identified text blocks.

6. The computing system of claim 1, wherein the memory further has contents that, based on execution by the one or more processors:
before injection of the panels, receiving input representing a user interaction with one or more distinguished text blocks,
and wherein the identifying is performed in response to receiving the input and identifies the distinguished text block.

7. One or more memories collectively containing a web page data structure, the web page data structure comprising:
one or more text blocks; and
a directive specifying an aspect of injecting one or more visually homogenous panels into the web page behind one or more of the one or more text blocks during composition of the web page.

8. The one or more memories of claim 7 wherein the directive is a value specified for an attribute of at least one of a paragraph tag and a style attribute.

9. The one or more memories of claim 7 wherein the directive is a value specified for an attribute of a ms-high-contrast media feature.

10. The one or more memories of claim 7 wherein the directive specifies a color for one or more of the one or more panels.

11. The one or more memories of claim 7 wherein the directive specifies an opacity level for one or more of the one or more panels.

12. The one or more memories of claim 7 wherein the directive specifies a minimum distance by which one or more of the one or more panels are to extend beyond the text of the text blocks.

13. The one or more memories of claim 7 wherein the directive specifies a degree to which corners of one or more of the one or more panels are to be rounded.

14. The one or more memories of claim 7 wherein the directive specifies that panels are not to be injected behind one or more of the text blocks.

15. One or more memories collectively having contents configured to cause a computing system to:
receive information specifying a web page, the received information specifying inclusion of one or more text blocks into the specified web page;
construct the web page specified by the received information; and
before the constructed web page is displayed, incorporate into the constructed web page one or more visually homogenous panels, the incorporated one or more panels being below the one or more text blocks in Z-order, the incorporated one or more panels being above content of the web page specified by the received information to be below the one or more text blocks in Z-order, the incorporated one or more panels placed such that, for each character of any of each of the one or more text blocks, one of the one or more incorporated panel extends behind the character.

16. The one or more memories of claim 15, further having contents configured to cause a computing system to:
cause the constructed web page to be displayed after incorporation of the one or more panels.

17. The one or more memories of claim 15 wherein the incorporating is performed irrespective of content specified for the web page other than the one or more text blocks specified for the web page.

18. The one or more memories of claim 15 wherein one or more of the one or more incorporated panel obscures at least a portion of visual content specified by the received information to occur below at least a portion of at least one of the one or more text blocks in Z-order.

19. The one or more memories of claim 15 wherein, within the constructed web page, text of the one or more text blocks are rendered in a first user-controllable color, and the one or more panels are rendered in a second user-controllable color.

20. The one or more memories of claim 15, further having contents configured to cause a computing system to:
in incorporating the one or more panels, respond to at least one directive contained by the received information specifying how panels are to be incorporated into the constructed web page.
